(19) United States
(12) Patent Application Publication
(10) Pub. No.: US 2025/0294637 A1
(43) Pub. Date: Sep. 18, 2025

(54) METHOD, USER EQUIPMENT, AND BASE STATION, FOR COMMUNICATING BASED ON AN INDICATED TRANSMISSION CONFIGURATION INDICATOR STATE

(71) Applicant: SHARP KABUSHIKI KAISHA, Sakai City, Osaka (JP)

(72) Inventors: WAN-CHEN LIN, Taipei (TW); MEI-JU SHIH, Taipei (TW); CHIA-HUNG LIN, Taipei (TW)

(21) Appl. No.: 18/861,331

(22) PCT Filed: Apr. 27, 2023
(86) PCT No.: PCT/CN2023/091361

§ 371 Date: Oct. 29, 2024

Related U.S. Application Data
(60) Provisional application No. 63/336,982, filed on Apr. 29, 2022.

(51) Int. Cl. H04W 76/20; H04L 5/00; H04W 72/12; H04W 72/231

(52) U.S. Cl. CPC H04W 76/20; H04L 5/0051; H04W 72/12; H04W 72/231

(57) ABSTRACT

A method performed by a user equipment (UE) for communicating based on an indicated Transmission Configuration Indicator (TCI) state is provided. The method receives, from a base station (BS), a Radio Resource Control (RRC) configuration for configuring multiple Transmission Configuration Indicator (TCI) fields. The method receives, from the BS, a Medium Access Control (MAC) Control Element (CE) activating at least one TCI state associated with the multiple TCI fields. The method receives, from the BS, a downlink control information (DCI) message including multiple DCI fields that is associated with the received RRC configuration and that indicates at least one first TCI state among the activated at least one TCI state. The method performs, based on the indicated at least one first TCI state, at least one downlink reception or at least one uplink transmission.

### CROSS-REFERENCE TO RELATED APPLICATION(S)

The present disclosure is a National Stage Application of International Patent Application Serial No. PCT/CN2023/091361, filed on Apr. 27, 2023, which claims the benefit of and priority to U.S. Provisional Patent Application Ser. No. 63/336,982, filed on Apr. 29, 2022, the contents of all of which are hereby incorporated herein fully by reference in their entirety for all purposes.

### TECHNICAL FIELD

The present disclosure generally relates to wireless communications, and more particularly, to a method, a user equipment (UE), and a base station (BS), for communicating based on an indicated Transmission Configuration Indicator (TCI) state.

### BACKGROUND

With the tremendous growth in the number of connected devices and the rapid increase in user/network traffic volume, various efforts have been made to improve different aspects of wireless communication for the next-generation wireless communication system, such as the fifth generation (5G) New Radio (NR), by improving data rate, latency, reliability, and mobility. The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC).

New Radio (NR) supports downlink transmission of the same NR-Physical Downlink Shared Channel (NR-PDSCH) data stream(s) from multiple Transmission/Receiving Points (TRPs) at least with ideal backhaul, and different NR-PDSCH data streams from multiple TRPs with both ideal and non-ideal backhaul. The ideal backhaul allows a single Physical Downlink Control Channel (PDCCH) received from one TRP to schedule data transmissions across multiple TRPs (single-DCI based multi-TRP/panel PDSCH transmission). It can also schedule a UL grant, allowing a UE to transmit data or information to multiple TRPs (single-DCI based multi-TRP/panel PUSCH/PUCCH transmission). The non-ideal backhaul may require each TRP to have its own PDCCH to independently schedule corresponding data transmission (multi-DCI based multi-TRP PDSCH transmission). The UE panel information may be derived from TCI state/UL beam indication information or network signaling.

In 3GPP NR specification release 15 (Rel-15), a scalable and highly flexible multiple- input-multiple-output (MIMO) framework was introduced, which supports advanced beam management operations and flexible acquisition of channel state information (CSI).

The term “beam” here may be replaced by spatial filter. For example, when a UE reports a preferred gNB TX beam, the UE is essentially selecting a spatial filter used by the gNB. The term “beam information” is used to provide information about which beam/spatial filter is being used/selected.

In NR Rel-16 work item, to achieve the increasing robustness, lower overhead, and lower latency, enhancements on multi-user-MIMO (MU-MIMO) support, multi-TRP/panel transmission including improved reliability and robustness with both ideal and non-ideal backhaul, and multi-beam operation which is primarily targeting the FR2 operation are implemented. More specifically, a multi-TRP based PDSCH repetition operation is introduced in Rel-16 to prevent the reception from being blocked due to receiving data using different beams.

In NR Rel-17, to enhance reliability for the whole system, multi-TRP based PDCCH repetition, multi-TRP based PUCCH repetition, and multi-TRP based PUSCH repetition are deployed accordingly.

Time domain multiplexing (TDM) based PDCCH repetition: two PDCCHs with the same DCI format, DCI payload, number of CCEs, number of candidates for each AL in two search spaces associated with two CORESETs are linked together.

TDM based PDSCH repetition: slot-based PDSCHs with the same TB or non-slot-based PDSCHs with the same TB corresponding to different TRPs, where slot-based PDSCHs may correspond to scheduling each repetitive PDSCH in each slot and non-slot-based PDSCHs may correspond to scheduling multiple repetitive PDSCHs within a slot.

TDM based PUCCH repetition: inter-slot based PUCCH transmissions and intra-slot based PUCCH transmissions with the same UCI content corresponding to different beams for all PUCCH formats in time manners, where the inter-slot based PUCCH transmissions may correspond to transmitting each repetitive PUCCH in each slot and intra-slot based PUCCH transmissions may correspond to transmitting each repetitive PUCCH in each slot and transmitting multiple repetitive PDSCHs within a slot.

TDM based PUSCH repetition: slot-based PUSCH transmissions with the same transport block (TB) or non-slot-based PUSCHs with same TB corresponding to different TRPs, where slot-based PUSCHs may correspond to scheduling each repetitive PUSCH in each slot and non-slot-based PUSCHs may correspond to scheduling multiple repetitive PUSCHs within a slot.

Frequency domain multiplexing (FDM) based PDSCH repetition: PDSCHs with the same TB corresponding to two TCI states for non-overlapped frequency resource allocation within a slot.

A TCI state contains parameters for configuring a QCL relationship between one or two reference signals and a target reference signal set. For example, a target reference signal set may be the DM-RS ports of PDSCH, PDCCH, PUCCH or PUSCH. The one or two reference signals may include UL or DL reference signals. In NR Rel-15/16, TCI state is used for a DL QCL indication whereas spatial relation information is used for providing UL spatial transmission filter information for UL signal(s) or UL channel(s). Here, a TCI state may refer to information provided similar to spatial relation information, which could be used for UL transmission. In other words, from UL perspective, a TCI state provides a UL beam information which may provide the information for a relationship between a UL transmission and DL or UL reference signals (e.g., CSI-RS, SSB, SRS, PTRS).

Multi-downlink control information (Multi-DCI) based PDSCH scheme: two PDCCHs from separate search spaces associated with different Control resource set (CORESET) pool index schedule corresponding PDSCHs.

SFN (Single Frequency Network) based PDCCH scheme: a CORESET is associated with two different beams.

SFN based PDSCH scheme: a PDSCH is associated with two different beams.

A UE can be configured with a list including up to M Transmission Configuration Indication (TCI)-state configurations, where each TCI-State contains parameters for configuring at least one quasi co-location (QCL) relationship between one or two downlink reference signals and the DM-RS ports of the PDSCH, the DM-RS port of PDCCH or the CSI-RS port(s) of a CSI-RS resource. The QCL types corresponding to each DL RS are given by the higher layer (e.g., RRC layer) parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

When signals transmitted from different antenna ports propagate through radio channels with common properties, the antenna ports are said to be QCL signals. Basically, the QCL concept is introduced to help the UE with channel estimation, frequency offset error estimation, and synchronization procedures.

To facilitate more efficient (lower latency and overhead) DL/UL beam management to support a larger number of configured TCI states, a unified TCI framework for beam indication is introduced. More specifically, through the unified indication, DL or UL channels/signals can share the same indicated TCI state to reduce the signaling overhead, and different channels and/or reference signals can share similar channel properties. The unified indication can be used to indicate a unified TCI state for DL channels (including PDCCH, PDSCH, and/or DL reference signal), a unified TCI state for UL channels (including PUCCH, PUSCH, and/or UL reference signal), and/or a unified TCI state for both DL and UL channels.

However, how the communication system works in the case where the unified TCI state is used with multi-TRP is still to be determined in the standard.

### SUMMARY

The present disclosure is directed to methods and apparatuses for communicating based on an indicated Transmission Configuration Indicator state.

Embodiments of the disclosure provide a UE including at least one non-transitory computer-readable medium and at least one processor. The at least one non-transitory computer-readable medium stores one or more computer-executable instructions. The at least one processor is coupled to the at least one non-transitory computer-readable medium, and the at least one processor is configured to execute the one or more computer-executable instructions to cause the UE to: receive, from a base station (BS), a Radio Resource Control (RRC) configuration that configures, to the UE, multiple Transmission Configuration Indicator (TCI) fields; receive, from the BS, a Medium Access Control (MAC) Control Element (CE) that activates at least one TCI state associated with the multiple TCI fields; receive, from the BS, a downlink control information (DCI) message including multiple DCI fields that is associated with the received RRC configuration and that indicates at least one first TCI state among the activated at least one TCI state; and perform, based on the indicated at least one first TCI state, at least one downlink reception or at least one uplink transmission.

Embodiments of the disclosure provide a method perform by a user equipment (UE) for communicating based on an indicated Transmission Configuration Indicator (TCI) state. The method includes: receiving, from a base station (BS), a Radio Resource Control (RRC) configuration that configures, to the UE, multiple Transmission Configuration Indicator (TCI) fields; receiving, from the BS, a Medium Access Control (MAC) Control Element (CE) that activates at least one TCI state associated with the multiple TCI fields; receiving, from the BS, a downlink control information (DCI) message including multiple DCI fields that is associated with the received RRC configuration and that indicates at least one first TCI state among the activated at least one TCI state; and performing, based on the indicated at least one first TCI state, at least one downlink reception or at least one uplink transmission.

Embodiments of the disclosure provide a base station (BS) including at least one non-transitory computer-readable medium and at least one processor. The at least one non-transitory computer-readable medium stores one or more computer-executable instructions. The at least one processor is coupled to the at least one non-transitory computer-readable medium, and the at least one processor is configured to execute the one or more computer-executable instructions to cause the BS to: transmit, to a user equipment (UE), a Radio Resource Control (RRC) configuration that configures, to the UE, multiple Transmission Configuration Indicator (TCI) fields; transmit, to the UE, a Medium Access Control (MAC) Control Element (CE) that activates at least one TCI state associated with the multiple TCI fields; transmit, to the UE, a downlink control information (DCI) message including multiple DCI fields that is associated with the received RRC configuration and that indicates at least one first TCI state among the activated at least one TCI state; and perform, based on the indicated at least one first TCI state, at least one downlink transmission or at least one uplink reception.

Embodiments of the disclosure provide a method performed by a base station (BS) for communicating based on an indicated Transmission Configuration Indicator (TCI) state. The method includes: transmitting, to a user equipment (UE), a Radio Resource Control (RRC) configuration that configures, to the UE, multiple Transmission Configuration Indicator (TCI) fields; transmitting, to the UE, a Medium Access Control (MAC) Control Element (CE) that activates at least one TCI state associated with the multiple TCI fields; transmitting, to the UE, a downlink control information (DCI) message including multiple DCI fields that is associated with the received RRC configuration and that indicates at least one first TCI state among the activated at least one TCI state; and performing, based on the indicated at least one first TCI state, at least one downlink transmission or at least one uplink reception.

### BRIEF DESCRIPTION OF DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 shows a schematic diagram of TRP index included in a unified TCI states activation/deactivation MAC CE according to an embodiment of the disclosure.

FIG. 2 shows a schematic diagram of two dimensional field Pi,j according to an embodiment of the disclosure.

FIG. 3 shows a schematic diagram of TCI states mapping order for two TRPs in TRP-based order according to an embodiment of the disclosure.

FIG. 4 shows another schematic diagram of TCI states mapping order for two TRPs in TCI state-based order according to an embodiment of the disclosure.

FIG. 5 shows a schematic diagram of Unified TCI states activation/deactivation MAC CE with CORESET ID.

FIG. 6 shows a schematic diagram of Unified TCI states activation/deactivation MAC CE with CORESETPoolIndex.

FIG. 7 illustrates a block diagram of a node for wireless communication, in accordance with various aspects of the present application.

FIG. 8 shows a flow chart of the method for communicating based on indicated TCI state according to an embodiment of the disclosure.

FIG. 9 shows another flow chart of the method for communicating based on indicated TCI state according to an embodiment of the disclosure.

### DESCRIPTION OF EMBODIMENTS

The acronyms in the present disclosure are defined as follows and unless otherwise specified, the acronyms have the following meanings:

| Acronym | Full name |
|---|---|
| 3GPP | 3^{rd} Generation Partnership Project |
| 5GC | 5G Core |
| ACK | Acknowledgement |
| ARQ | Automatic Repeat Request |
| BS | Base Station |
| BWP | Bandwidth Part |
| CA | Carrier Aggregation |
| CN | Core Network |
| CORESET | Control Resource Set |
| C-RNTI | Cell-Radio Network Temporary Identifier |
| DC | Dual Connectivity |
| DCI | Downlink Control Information |
| DL | Downlink |
| HARQ | Hybrid Automatic Repeat Request |
| IE | Information Element |
| MAC | Medium Access Control |
| MCG | Master Cell Group |
| MIMO | Multiple Input Multiple Output |
| NG-RAN | Next-Generation Radio Access Network |
| NR | New Radio |
| NW | Network |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PRACH | Physical Random Access Channel |
| PUCCH | Physical Uplink Control Channel |
| PUSCH | Physical Uplink Shared Channel |
| RA | Random Access |
| RACH | Random Access Channel |
| RAN | Radio Access Network |
| Rel | Release |
| RLC | Radio Link Control |
| RNTI | Radio Network Temporary Identifier |
| RRC | Radio Resource Control |
| SCell | Secondary Cell |
| SCG | Secondary Cell Group |
| SCS | Sub Carrier Spacing |
| SDAP | Service Data Adaptation Protocol |
| SDU | Service Data Unit |
| SFN | System Frame Number |
| SI | System Information |
| TS | Technical Specification |
| UCI | Uplink Control Information |
| UE | User Equipment |
| UL | Uplink |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the consistency and ease of understanding, like features are identified (although, in some examples, not shown) by numerals in the example figures. However, the features in different implementations may be differed in other respects, and thus shall not be narrowly confined to what is shown in the figures.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent.

Additionally, for the purposes of explanation and non-limitation, specific details, such as functional entities, techniques, protocols, standard, and the like are set forth for providing an understanding of the described technology. In other examples, detailed description of well-known methods, technologies, system, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules may be software, hardware, firmware, or any combination thereof. The software implementation may comprise computer executable instructions stored on computer readable medium such as memory or other type of storage devices. For example, one or more microprocessors or general purpose computers with communication processing capability may be programmed with corresponding executable instructions and carry out the described network function(s) or algorithm(s). The microprocessors or general purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read Only Memory (CD ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, or an LTE-Advanced Pro system) typically includes at least one base station, at least one User Equipment (UE), and one or more optional network elements that provide connection towards a network. The UE communicates with the network (e.g., a Core Network (CN), an Evolved Packet Core (EPC) network, an Evolved Universal Terrestrial Radio Access Network (E-UTRAN), a Next-Generation Core (NGC), or an internet) through a Radio Access Network (RAN) established by the base station.

It should be noted that, in the present application, a UE may include, but is not limited to, a mobile station, a mobile terminal or device, a user communication radio terminal, etc. For example, a UE may be a portable radio equipment, which includes, but is not limited to, a mobile phone, a tablet, a wearable device, a sensor, or a Personal Digital Assistant (PDA) with wireless communication capability. The UE is configured to receive/transmit signals over an air interface from/to one or more cells in a radio access network.

A base station may include, but is not limited to, a Node B (NB) as in the UMTS, an evolved Node B (eNB) as in the LTE-A, a Radio Network Controller (RNC) as in the UMTS, a Base Station Controller (BSC) as in the GSM/GERAN, an NG-eNB as in an E-UTRA base station in connection with the 5GC, a next generation Node B (gNB) as in the 5G-AN, and any other apparatus capable of controlling radio communication and managing radio resources within a cell. The base station may connect to serve the one or more UEs through a radio interface to the network.

A base station may be configured to provide communication services according to at least one of the following Radio Access Technologies (RATs): Worldwide Interoperability for Microwave Access (WiMAX), Global System for Mobile communications (GSM, often referred to as 2G), GSM EDGE radio access Network (GERAN), General Packet Radio Service (GRPS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE), New Radio (NR, often referred to as 5G), and/or LTE-A Pro. However, the scope of the present application should not be limited to the above mentioned protocols.

The base station is operable to provide radio coverage to a specific geographical area using multiple cells forming the radio access network. The base station supports the operations of the cells. Each cell is operable to provide services to at least one UE within its radio coverage. More specifically, each cell (often referred to as a serving cell) provides services to serve one or more UEs within its radio coverage, (e.g., each cell schedules the downlink and optionally uplink resources to at least one UE within its radio coverage for downlink and optionally uplink packet transmissions). The base station can communicate with one or more UEs in the radio communication system through the plurality of cells. A cell may allocate SideLink (SL) resources for supporting Proximity Service (ProSe). Each cell may have overlapped coverage areas with other cells.

As discussed above, the frame structure for NR is to support flexible configurations for accommodating various next generation (e.g., 5G) communication requirements, such as enhanced Mobile BroadBand (eMBB), massive Machine Type Communication (mMTC), Ultra-Reliable communication and Low Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP), may also be used. Additionally, two coding schemes are considered for NR: (1) Low-Density Parity-Check (LDPC) code and (2) polar code. The coding scheme adaption may be configured based on the channel conditions and/or the service applications.

Moreover, it should be noted that in a transmission time interval TX of a single NR frame, at least DownLink (DL) transmission data, a guard period, and UpLink (UL) transmission data should be included. Additionally, the respective portions of the DL transmission data, the guard period, and the UL transmission data should also be configurable, for example, based on the network dynamics of NR. In addition, SL resource may also be provided in an NR frame to support ProSe services.

In addition, the terms “system” and “network” herein may be used interchangeably. The term “and/or” and “or/and” herein is only an association relationship for describing associated objects, and represents that three relationships may exist. For example, A and/or B may indicate that: A exists alone, A and B exist at the same time, and B exists alone. In addition, the character “/” herein generally represents that the former and latter associated objects are in an “or” relationship. For example, A and/or B may indicate that: A exists alone, A and B exist at the same time, and B exists alone.

For single TRP operation, a unified TCI state can be indicated through the RRC message, the activation/deactivation MAC CE, and DCI. More specifically, the RRC message indicates whether the unified framework is enabled or not, the activation/deactivation MAC CE indicates where the unified TCI framework applies, and DCI further indicates which unified TCI state is applied. In more detail, information being contained in the activation/deactivation MAC CE may refer to serving cell index, DL BWP index, UL BWP index, the number of TCI states included in each codepoint, transmission direction where TCI state applies, and/or TCI state index. However, when the unified TCI framework applies to multiple TRP, which TRP the activation/deactivation MAC CE refers to and how to enable unified TCI framework for multiple TRP need to be clarified. Since multiple TRP may correspond to different schemes, for example, TDM scheme, multi-DCI scheme, and SFN scheme, different impact may be considered when applying the unified TCI framework (including DL only, UL only, and/or joint indication) to different schemes for multiple TRP.

The following cases are listed as possible scenarios where the unified TCI framework applies, but where the following implementations applies is not limited to the listed cases.

In the embodiments of the disclosure, when at least one DL channel operates on multiple TRP upon Time Domain Multiplexing (TDM) scheme, and UL channels operate on single TRP scheme, at least one of the following approaches can be applied. Preferably, PDCCHs are transmitted/received from multiple TRP; PDSCHs are transmitted/received from single TRP; PUCCHs and PUSCHs are transmitted/received from single TRP. Preferably, PDCCHs are transmitted/received from single TRP; PDSCHs are transmitted/received from multiple TRP; PUCCHs and PUSCHs are transmitted/received from single TRP. Preferably, PDCCHs are transmitted/received from multiple TRP; PDSCHs are transmitted/received from multiple TRP; PUCCHs and PUSCHs are transmitted/received from single TRP.

In the embodiments of the disclosure, when at least one DL channel operates on multiple TRP upon TDM scheme, and at least one UL channel operates on multiple TRP upon TDM scheme, at least one of the following approaches can be applied. Preferably, PDCCHs are transmitted/received from multiple TRPs; PDSCHs are transmitted/received from single TRP; PUCCHs are transmitted/received from multiple TRPs; PUSCHs are transmitted/received from single TRP. Preferably, PDCCHs are transmitted/received from multiple TRPs; PDSCHs are transmitted/received from single TRP; PUCCHs are transmitted/received from single TRP; PUSCHs are transmitted/received from multiple TRPs. Preferably, PDCCHs are transmitted/received from single TRP; PDSCHs are transmitted/received from multiple TRPs; PUCCHs are transmitted/received from multiple TRPs; PUSCHs are transmitted/received from single TRP. Preferably, PDCCHs are transmitted/received from single TRP; PDSCHs are transmitted/received from multiple TRPs; PUCCHs are transmitted/received from single TRP; PUSCHs are transmitted/received from multiple TRPs. Preferably, PDCCHs are transmitted/received from multiple TRPs; PDSCHs are transmitted/received from multiple TRPs; PUCCHs are transmitted/received from single TRP; PUSCHs are transmitted/received from multiple TRPs. Preferably, PDCCHs are transmitted/received from multiple TRPs; PDSCHs are transmitted/received from multiple TRPs; PUCCHs are transmitted/received from multiple TRPs; PUSCHs are transmitted/received from single TRP. Preferably, PDCCHs are transmitted/received from single TRP; PDSCHs are transmitted/received from multiple TRPs; PUCCHs are transmitted/received from multiple TRPs; PUSCHs are transmitted/received from multiple TRPs. Preferably, PDCCHs are transmitted/received from multiple TRPs; PDSCHs are transmitted/received from single TRP; PUCCHs are transmitted/received from multiple TRPs; PUSCHs are transmitted/received from multiple TRPs.

In the embodiments of the disclosure, when PDSCHs are transmitted/received from multiple TRPs upon multi-DCI scheme, and UL channels operate on single TRP scheme.

In the embodiments of the disclosure, when PDSCHs are transmitted/received from multiple TRPs upon multi-DCI scheme, and at least one UL channels operate on multiple TRPs upon TDM scheme, at least one of the following approaches can be applied. Preferably, PDCCHs are associated with different TCI states or different CORESET pool indices; PDSCHs are transmitted/received from multiple TRPs; PUCCHs are transmitted/received from multiple TRPs; PUSCHs are transmitted/received from multiple TRPs. Preferably, PDCCHs are associated with different TCI states or different CORESET pool indices; PDSCHs are transmitted/received from multiple TRPs; PUCCHs are transmitted/received from single TRP; PUSCHs are transmitted/received from multiple TRPs. Preferably, PDCCHs are associated with different TCI states or different CORESET pool indices; PDSCHs are transmitted/received from multiple TRPs; PUCCHs are transmitted/received from multiple TRPs; PUSCHs are transmitted/received from single TRP.

In the embodiments of the disclosure, when at least one DL channel operates on multiple TRPs upon SFN scheme, and UL channels operate on single TRP scheme, at least one of the following approaches can be applied. Preferably, a CORESET is associated with multiple TCI states; a PDSCH is associated with single TCI state; PUCCHs and PUSCHs are transmitted/received with single TCI state from single TRP. Preferably, a CORESET is associated with multiple TCI states; a PDSCH is associated with multiple TCI states; PUCCHs and PUSCHs are transmitted/received with single TCI state from single TRP. Preferably, a CORESET is associated with two TCI states; a PDSCH is associated with multiple TCI states.; PUCCHs and PUSCHs are transmitted/received with single TCI state from single TRP.

In the embodiments of the disclosure, when at least one DL channel operates on multiple TRPs upon SFN scheme, and at least one UL channels operates on multiple TRPs upon TDM scheme, at least one of the following approaches can be applied. Preferably, a CORESET is associated with multiple TCI states; a PDSCH is associated with single TCI state; PUCCHs are transmitted/received from multiple TRPs; PUSCHs are transmitted/received from single TRP. Preferably, a CORESET is associated with multiple TCI states; a PDSCH is associated with single TCI state; PUCCHs are transmitted/received from single TRP; PUSCHs are transmitted/received from multiple TRPs. Preferably, a CORESET is associated with multiple TCI states; a PDSCH is associated with single TCI state; PUCCHs are transmitted/received from multiple TRPs; PUSCHs are transmitted/received from multiple TRPs. Preferably, a CORESET is associated with single TCI state; a PDSCH is associated with multiple TCI states; PUCCHs are transmitted/received from multiple TRPs; PUSCHs are transmitted/received from single TRP. Preferably, a CORESET is associated with single TCI state; a PDSCH is associated with multiple TCI states; PUCCHs are transmitted/received from single TRP; PUSCHs are transmitted/received from multiple TRPs. Preferably, a CORESET is associated with single TCI state; a PDSCH is associated with multiple TCI states; PUCCHs are transmitted/received from multiple TRPs; PUSCHs are transmitted/received from multiple TRPs. Preferably, a CORESET is associated with multiple TCI states; a PDSCH is associated with multiple TCI states; PUCCHs are transmitted/received from single TRP; PUSCHs are transmitted/received from multiple TRPs. Preferably, a CORESET is associated with multiple TCI states; a PDSCH is associated with multiple TCI states; PUCCHs are transmitted/received from multiple TRPs; PUSCHs are transmitted/received from single TRP. Preferably, a CORESET is associated with multiple TCI states; a PDSCH is associated with multiple TCI states; PUCCHs are transmitted/received from multiple TRPs; PUSCHs are transmitted/received from multiple TRPs.

In the embodiments for the unified TCI activation/deactivation MAC CE, at least one of the following approaches can be applied. In one embodiment, at least one field associated with TRP index may be included in the MAC CE. In one embodiment, each MAC CE may apply to each TRP. In one embodiment, the field for indicating whether each codepoint has multiple TCI states or single TCI state may refer to a two dimensional field, for example, Pi,j, to indicate one or more than one TCI state for each TRP. In one embodiment, the field Pi may correspond to more than two TCI states. In one embodiment, the field ‘D/U’ for indicating DL TCI state and UL TCI state may correspond to respective TRP. In one embodiment, the mapping order of indication for DL TCI state and UL TCI state may be arranged. In one embodiment, the mapping order of indication for TCI state corresponding to a first TRP and TCI state corresponding to a second TRP may be arranged. In one embodiment, the field TCI state ID for indicating TCI state may denote to different TCI state for each TRP. In one embodiment, a field may be included in the MAC CE to indicate which channel that the unified TCI state applies. In one embodiment, a field may be included in the MAC CE to indicate whether the octet containing TCI associated with different TRPs is present. In one embodiment, a field may be included in the MAC CE to indicate a multiple-TRP scheme. In one embodiment, each multiple-TRP scheme may correspond to a MAC CE for indicating respective unified TCI state. In one embodiment, CORESET index may be included in the MAC CE. In one embodiment, CORESETPoolindex may be included in the MAC CE. In one embodiment, one field corresponding to the index of the TCI fields may be included in the MAC CE. In one embodiment, one DCI may include multiple TCI fields to indicate DL TCI states, UL TCI states, and/or joint TCI states for MTRP or SFN based operation. Each TCI field may be associated with one TRP.

In the embodiments for the configuration for extension of unified TCI states for multiple-TRP operation, at least one of the following approaches can be applied.

In some embodiments, an RRC parameter may be used to configure the unified TCI framework for each TRP. In some embodiments, an RRC parameter may be used to configure a list (of TCI states) to update TCI states for each TRP simultaneously. In some embodiments, the configuration may indicate that the unified TCI framework (only) applies to channels corresponding to the same number of TRP. In some embodiments, the configuration may indicate that which channel applies the indicated joint TCI state, and/or the linkage between TCI state of each channel may be further configured.

In some embodiments, a UE does not expect to receive a configuration that indicates SFN scheme and receive a configuration that indicates the unified TCI framework at the same time. For example, if the UE is configured with SFN scheme, the UE may not expect to receive a configuration for the unified TCI framework. If the UE is configured with the unified TCI framework, the UE may not expect to receive a configuration for the SFN scheme.

In some embodiments, a RRC parameter may be used to indicate whether a single DCI includes two TCI fields or not. In one embodiment, a RRC parameter may be used to indicate whether a TCI field included in a DCI may indicate two TCI codepoint indexes or not. In some embodiments, each TCI codepoint index may be associated with different TRPs.

In some embodiments, one RRC parameter may be used to indicate to the UE whether to apply unified TCI framework for data transmission/reception and another RRC parameter may be used to indicate to the UE whether to perform multi-TRP/SFN based operation (e.g., multi-TRP based PDCCH/PDSCH reception, multi-TRP based PUCCH/PUSCH transmission or SFN based PDCCH/PDSCH reception). If RRC parameters indicate to the UE to apply unified TCI framework for data transmission/reception and to perform multi-TRP/SFN based operation, the scheduling PDCCH may include two TCI fields. If RRC parameters indicate to the UE to apply unified TCI framework for data transmission/reception and to perform multi-TRP/SFN based operation, the TCI field included in scheduling PDCCH may contain two TCI codepoint indices.

In the embodiments regarding DCI for indicating unified TCI states for multiple TRP, at least one of the following approaches can be applied.

In some embodiments, more than one TCI codepoint may be included in the DCI. In some embodiments, the codepoint may be used to further activate TCI states for separate TCI state and/or joint TCI state. In some embodiments, a field in DCI scheduling a transmission/reception may be used to indicate different multiple TRP schemes. In some embodiments, the linkage between TCI states for different channels from different TRPs may be indicated by DCI. In some embodiments, when a CORESET is configured with more than one TCI states, joint TCI state may be indicated according to one of the more than one TCI states. In some embodiments, when a UE receives more than one DCI from different CORESETs, the indicated joint TCI state may base on the respective TCI state of each CORESET. In some embodiments, more than one TCI field may be included in the DCI, and one TCI field may be associated with different TRPs and one other TCI field may indicate the mapping order of the indicated TCI states. In some embodiments, more than one TCI codepoint index may be indicated in the TCI field included in the DCI, and each TCI codepoint index may be associated with different TRPs.

Any two or more than two of the following paragraphs, (sub)-bullets, points, actions, behaviors, terms, or claims described in the following invention(s) may be combined logically, reasonably, and properly to form a specific method.

Any sentence, paragraph, (sub)-bullet, point, action, behaviors, terms, or claims described in the following invention(s) may be implemented independently and separately to form a specific method.

Dependency, e.g., “based on”, “more specifically”, “preferably”, “In one embodiment”, or etc., in the following invention(s) is just one possible example which would not restrict the specific method.

A and/or B in following paragraph may refer to either A or B, both A and B, at least one of A and B.

It is noted that ‘TRP’ in the implementations or the examples may be replaced by ‘beam’ or ‘panel’. It is noted that ‘overlap’ may refer to time domain overlapping.

The following paragraphs provide discussions about possible approaches for TRP identification.

In one aspect, different channels/resources corresponding to the same TRP may mean that different channels/resources correspond to the same SRI, SRS resource set, Transmission Precoding Matrix Indicator (TPMI), TCI state, CORESETPoolIndex, CORESET, TCI configuration, power control parameter, spatial relation information, and/or unified TCI state ID. In one example, there may be no explicit indication on TRP information, and a default beam is determined based on a (pre-)configured/(pre-)determined rule.

In one aspect, different channels/resources corresponding to the same TRP may mean that the channels are using a same spatial domain filter/setting as for a reception of a SS/PBCH block.

In one aspect, different channels/resources corresponding to the same TRP may mean that the channels are using a same spatial domain filter/setting as for a reception of a periodic/semi-persistent/aperiodic CSI-RS resource.

In one aspect, different channels/resources corresponding to the same TRP may mean that the channels are applying a same spatial domain filter/setting to transmit toward the corresponding TRP.

In one aspect, different channels/resources corresponding to the same TRP may mean that the channels are using a same spatial domain filter/setting as for a transmission of an SRS. The SRS resource may be purposed for one of the following purposes: beam management, codebook-based channel sounding, non-codebook-based channel sounding. Preferably, it is purposed to beam management.

In one aspect, different channels/resources corresponding to the same TRP may mean that the channels are using a same spatial domain filter/setting as for PDCCH receptions corresponding to a same CORESET ID.

In one aspect, different channels/resources corresponding to the same TRP may mean that the channels are using a same spatial domain filter/setting as for PDCCH receptions whose associated CORESET index(es) corresponds to a same CORESET pool index.

In one aspect, different channels/resources corresponding to the same TRP may mean that the channels are indicated to the same set of power control parameters. In one example, power control parameters may refer to pathloss RS and Transmit Power Control (TPC) command.

The following paragraphs provide discussions about general mechanism for indication of unified TCI framework for multiple TRP operation.

In some implementations, a common indication of unified TCI state may apply to different multi-TRP schemes. Preferably, the common indication may refer to a RRC configuration, a RRC parameter, a dedicated MAC CE, a particular DCI format, a DCI field, and/or a DCI with CRC scrambled by a particular RNTI. Preferably, the common indication may (only) correspond to DL channels/signals or UL channels/signals, respectively. Preferably, the common indication may refer to an index, a list, and/or a sequence. Preferably, a UE may expect to receive the common indication to all configured multi-TRP scheme.

In some implementations, separate indications of unified TCI state may apply to each different multi-TRP schemes. Preferably, each separate indication may not expect to be configured/indicated simultaneously. Preferably, separate indication for each multi-TRP schemes may correspond to different configuration(s), different MAC CE(s), different DCI(s), and/or different combinations of above indications. More specifically, the combination may refer to using RRC configuration to a unified TCI state for a first multi-TRP scheme and using MAC CE to a unified TCI state for a second multi-TRP scheme.

In some implementations, an explicit indication may be used to indicate whether the unified TCI state is applied to the multi-TRP scheme. Preferably, the explicit indication may refer to a field in a MAC CE. For example, if the 1-bit field is set to 1, the octet containing TCI state for other TRPs is present. If the 1-bit field is set to 0, the octet containing TCI state for other TRPs is not present (or is absent). Preferably, the explicit indication may refer to a RRC parameter or a RRC configuration. In one example, if joint-mTRP is configured, the unified TCI state may apply to the multi-TRP scheme. In one example, the RRC parameter may be configured as ENUMERATED {mTRPschemeA mTRPschemeB mTRPschemeC}, and each scheme may correspond to a unified TCI framework for each multi-TRP scheme. Preferably, the explicit indication may refer to a DCI field. In one example, if the field is set to 1, the unified TCI state may apply to the multi-TRP scheme. If the field is set to 0, the unified TCI state may not apply to the multi-TRP scheme. In one example, an index may be used to indicate a specific multi-TRP scheme.

In some implementations, an explicit indication may be used to indicate which multi-TRP scheme the unified TCI framework applies to. Preferably, the explicit indication may refer to a field in a MAC CE. The referring scheme indicated by each bitfield value in following example may be exchangeable and not limited to the listed example. In one example, a 1-bit field set to 1 may refer to TDM-based multi-TRP scheme and a 1-bit field set to 0 may refer to FDM-based multi-TRP scheme. In one example, a 1-bit field set to 1 may refer to single DCI based multi-TRP scheme, and a 1-bit field set to 0 may refer to multi-DCI based multi-TRP scheme. In one example, a 2-bit field set to 00 may refer to TDM based multi-TRP scheme, a 2-bit field set to 01 may refer to FDM based multi-TRP scheme, a 2-bit field set to 10 may refer to multi-DCI based multi-TRP scheme, and a 2-bit field set to 11 may refer to SFN based multi-TRP scheme. Preferably, the explicit indication may refer to a RRC parameter or a RRC configuration. In one example, the indication may be included in PDC CH-Config, IE CORESET, PDSCH-Config, PUSCH-Config, ServingCell-Config, IE BWP-Downlink, IE BWP-Uplink, IE BWP, IE TCI-States, a dedicated configuration for unified TCI framework, and/or a dedicated configuration for multi-TRP scheme.

Preferably, the explicit indication may refer to a DCI field. Specifically, the DCI field may correspond to a RRC parameter or an entry of a table. In one example, a 1-bit field set to 1 may refer to TDM-based multi-TRP scheme and a 1-bit field set to 0 may refer to FDM-based multi-TRP scheme. In one example, a 1-bit field set to 1 may refer to single DCI based multi-TRP scheme, and a 1-bit field set to 0 may refer to multi-DCI based multi-TRP scheme. In one example, a 2-bit field set to 00 may refer to TDM based multi-TRP scheme, a 2-bit field set to 01 may refer to FDM based multi-TRP scheme, a 2-bit field set to 10 may refer to multi-DCI based multi-TRP scheme, and a 2-bit field set to 11 may refer to SFN based multi-TRP scheme.

In some implementations, a UE may not expect to receive unified TCI state indications from or in different multi-TRP schemes. Preferably, the UE may not expect to receive unified TCI state indications from different configurations. In one example, the UE may expect to receive unified TCI state indications from the same configuration, where each configuration may correspond to a multi-TRP scheme. Preferably, the UE may not expect to receive unified TCI state indications from different MAC CE. In one example, the UE may expect to receive unified TCI state indications from the same MAC CE, where each MAC CE may correspond to a multi-TRP scheme. Preferably, the UE may not expect to receive unified TCI state indications from different DCI field. In one example, the UE may expect to receive unified TCI state indications from the same DCI field, where each DCI field may correspond to a multi-TRP scheme.

In some implementations, a UE may not expect to receive unified TCI state indications to different channels/signals or different transmission direction. Preferably, the UE may expect to receive the indications indicating the same multi-TRP scheme for all DL channels/signals. Preferably, the UE may expect to receive the indications indicating the same multi-TRP scheme for all UL channels/signals. Preferably, the UE may expect to receive the indications indicating the same multi-TRP scheme for all channels/signals. Preferably, the UE may expect to receive same number of TCI states for each channel/signal. In one example, when multi-TRP is applied to PDCCH, the UE may expect to receive multi-TRP configuration for PDSCH, PUCCH, and PUSCH. In one example, when multi-TRP is applied to PDCCH, the UE may expect to receive multi-TRP configuration for PDSCH. In one example, when multi-TRP is applied to PUCCH, the UE may expect to receive multi-TRP configuration for PUSCH. Otherwise, single TRP may be applied if the number of TRPs indicated for each channel is different.

In some implementations, a UE capability may be used to indicate the supported unified TCI framework. Preferably, the UE capability may indicate whether to support the unified TCI framework to multi-TRP operation. Preferably, the UE capability may indicate the supported multi-TRP scheme.

The following paragraphs provide discussions about unified TCI states activation/deactivation MAC CE.

In some implementations, the UE may receive the unified TCI states activation/deactivation MAC CE transmitted by the BS, the TRP associated with the serving cell, and/or the TRP associated with a PCI different from the PCI of the serving cell. Upon the reception of the unified TCI states activation/deactivation MAC CE, the UE may apply (the information indicated in) the unified TCI states activation/deactivation MAC CE.

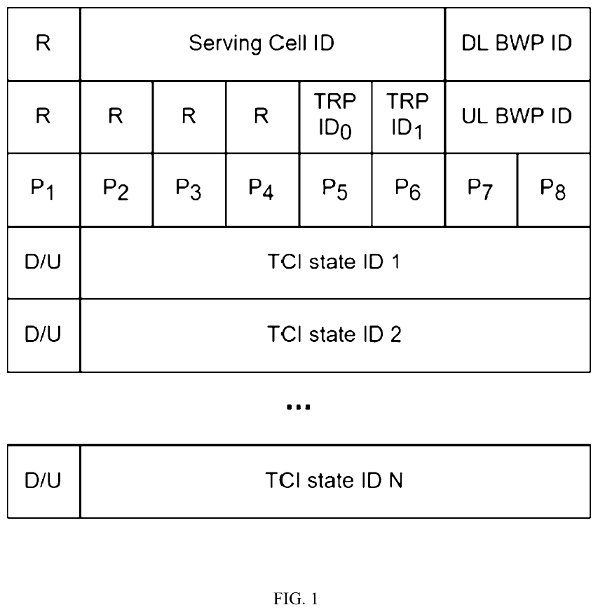

In some implementations, at least one field associated with a TRP indication may be included in a MAC CE for indicating unified TCI states activation/deactivation. Specifically, the MAC CE may refer to a unified TCI states activation/deactivation MAC CE or a MAC CE other than the unified TCI states activation/deactivation MAC CE (e.g., enhanced unified TCI states activation/deactivation MAC CE). Preferably, the unified TCI states activation/deactivation MAC CE may refer to the MAC CE for activating at least one TCI state for single TRP operation and the enhanced unified TCI states activation/deactivation MAC CE may refer to the MAC CE for activating at least one TCI state for multiple TRP operation. Preferably, the at least one field may refer to a TRP index, and/or a TRP group index. Preferably, the at least one field may use the reserved bit in the unified TCI states activation/deactivation MAC CE. Preferably, the TRP indication may refer to a single field. For example, a 1-bit field with value 0 may correspond to a first TRP and value 1 may correspond to a second TRP. Preferably, the TRP indication may refer to multiple fields and each field may correspond to a particular TRP index as illustrated in FIG. 1.

In some implementations, one unified TCI states activation/deactivation MAC CE may apply to a single TRP. More specifically, the MAC CE and the TRP may be a one-to-one mapping relationship and the number of the unified TCI states activation/deactivation MAC CE may be equal to the number of TRPs. In other words, there might be more than one unified TCI states activation/deactivation MAC CE used to indicate the activation/deactivation status for each TRP, and each MAC CE may be indicated to a UE on single TRP basis.

In some implementations, at least one field associated with a TCI field may be included in a MAC CE for indicating unified TCI states activation/deactivation. Specifically, the MAC CE may refer to a unified TCI states activation/deactivation MAC CE or a MAC CE other than the unified TCI states activation/deactivation MAC CE (e.g., enhanced unified TCI states activation/deactivation MAC CE). Preferably, the at least one field may refer to a TCI index. Preferably, the at least one field may use the reserved bit in the unified TCI states activation/deactivation MAC CE. Preferably, the TCI field indication may refer to a single field. For example, a 1-bit field with value 0 may correspond to a first TCI field and value 1 may correspond to a second TCI field.

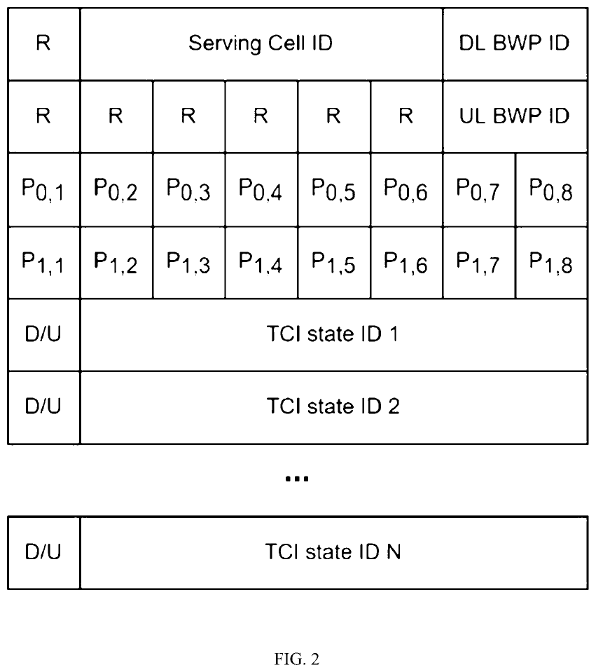

In some implementations, as illustrated in the FIG. 2, the field for indicating whether each codepoint has multiple TCI states or single TCI state in the unified TCI states activation/deactivation MAC CE may refer to a two dimensional field, for example, P_{i,j}, to indicate one or more than one TCI state for each TRP, where i may be the index of TRP and P_{i,j} may denote the jth joint status (joint DL only, joint UL only, or joint DL/UL) for each activated TCI state. Preferably, i and j may be exchangeable. Preferably, the field corresponding to each TRP may refer at most 8-status bit. More specifically, the field P_{i,j} for the first TRP may refer to P_{0,1}-P_{0,8} and the field P_{i,j} for the second TRP may refer to P_{1,1}-P_{1,8}.

In some implementations, each Pi for indicating whether each codepoint has multiple TCI states or single TCI state in the unified TCI states activation/deactivation MAC CE may correspond to more than two TCI states. In one example, assuming that multiple TRPs are configured to a UE, if Pi is set to 1, it indicates that ith TCI codepoints may include two DL TCI states and two UL TCI states to indicate TCI states for the UE. If Pi is set to 0, it indicates that ith TCI codepoints may include (only) two DL TCI states, single DL TCI state, single joint TCI state, two joint TCI states, single UL TCI state, or two UL TCI states.

In some implementations, the field for indicating whether each codepoint is applied for multi-TRP operation or not may be present. Preferably, there may be one field used to indicate whether each TCI codepoint contains two DL TCI states, two UL TCI states and/or two joint TCI states. In one example, if the field used to indicate whether each TCI codepoint contains two DL TCI states, two UL TCI states and/or two joint TCI states is set to ‘0’, it indicates all TCI codepoints may contain 4 TCI states (i.e., 2 DL only TCI states and 2 UL only TCI states) or 2 joint TCI states. Preferably, there may be multiple fields used to indicate whether the corresponding TCI codepoint contains two DL TCI states, two UL TCI states and/or two joint TCI states. It is noted that each field may be associated with one TCI codepoint. In one example, if the field used to indicate whether the i-th TCI codepoint contains two DL TCI states, two UL TCI states and/or two joint TCI states is set to ‘0’, it indicates i-th TCI codepoints may contain 4 TCI states (i.e., 2 DL only TCI states and 2 UL only TCI states) or 2 joint TCI states.

In some implementations, the field D/U in the MAC CE for indicating whether the TCI state ID in the same octet is for joint/DL or UL TCI state may correspond to more than one TRP. Preferably, assuming that two TRP are configured to a UE, if the field is set to 01, the TCI state ID in the same octet is for joint/DL for a first TRP. If the field is set to 00, the TCI state ID in the same octet is for UL for a first TRP. If the field is set to 11, the TCI state ID in the same octet is for UL for a second TRP. If the field is set to 10, the TCI state ID in the same octet is for joint/DL for a second TRP. Preferably, assuming that two TRP are configured to a UE, if the field is set to 10, the TCI state ID in the same octet is for joint/DL for a first TRP. If the field is set to 00, the TCI state ID in the same octet is for UL for a first TRP. If the field is set to 11, the TCI state ID in the same octet is for UL for a second TRP. If the field is set to 01, the TCI state ID in the same octet is for joint/DL for a second TRP. Preferably, assuming that two TRP are configured to a UE, the field may correspond to both TRPs.

In some implementations, the mapping order of indication for DL TCI state, UL TCI state, and joint TCI state may be arranged if the field Pi indicates more than one TCI states. Preferably, the DL TCI state may be mapped firstly. In one example, DL TCI state and joint TCI state may be indicated using same octet. Preferably, the UL TCI state may be mapped firstly. Preferably, the joint TCI state may be mapped firstly.

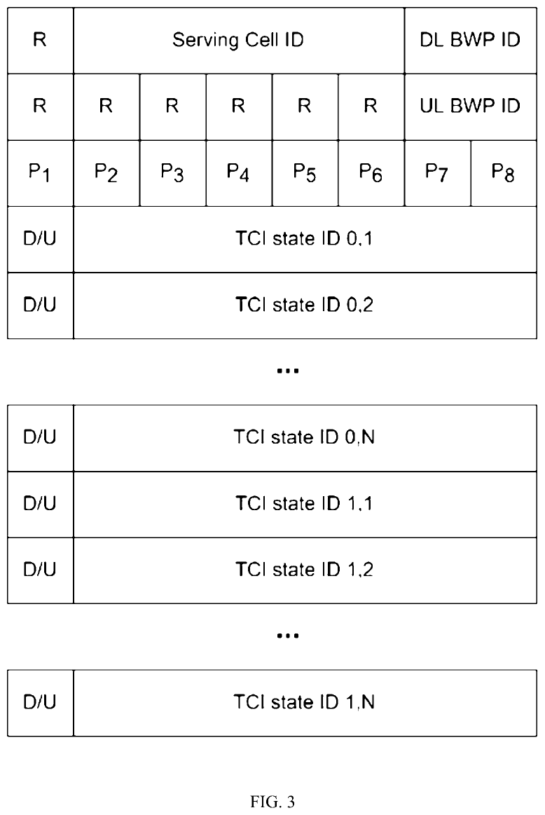

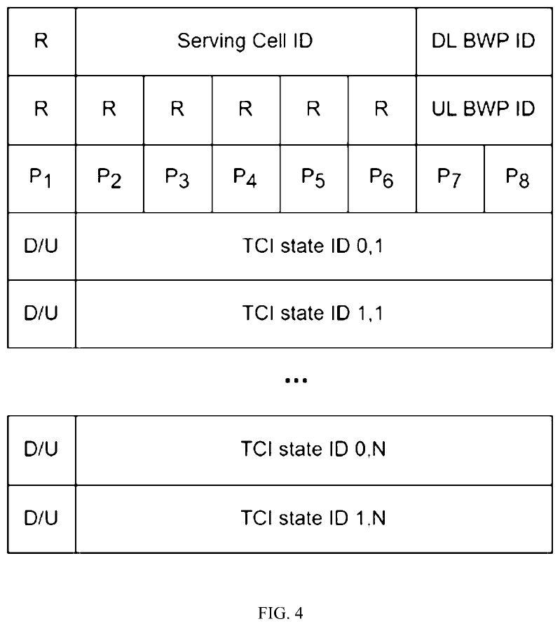

In some implementations, if there are two TRP configured to a UE, the mapping order of an indication for TCI state corresponding to a first TRP and an indication for TCI state corresponding to a second TRP may be arranged. Preferably, the TCI states for the first TRP may be listed before the TCI states for the second TRP as illustrated in FIG. 3. Specifically, TCI states for the first TRP may be mapped firstly and then TCI states for the second TRP may be mapped accordingly. Preferably, the first TCI state for the first TRP may be listed before the first TCI state for the second TRP, and then the second TCI state for the first TRP may be listed before the second TCI state for the second TRP as illustrated in the FIG. 4. Specifically, TCI states for the first TRP may be mapped firstly and then TCI states for the second TRP may be mapped accordingly.

In some implementations, the field TCI state ID for indicating TCI state may denote to different TCI states for each TRP. Preferably, TCI states for different TRPs may use same octet, which means that a single index may refer to more than one TCI states. Preferably, the field may correspond to an index, and the index may include more than one TCI states.

In some implementations, a field may be included in a unified TCI states activation/deactivation MAC CE to indicate which channels or signals that the unified TCI state applies. Preferably, the channels that the field indicate to may refer to PDCCH, PDSCH, PUCCH, and/or PUSCH. Preferably, the signals that the field indicate to may refer to DMRS, CSI-RS, SRS, PT-RS, and/or TRS. Preferably, the field may refer to an index, and the index may indicate the specific channel or signal.

In some implementations, a field may be included in a unified TCI states activation/deactivation MAC CE to indicate whether the octet containing TCI associated with different TRP is present. Preferably, the field may refer to a 1-bit indication, where value 1 indicates the following octet referring to TCI states for more than one TRP is present and value 0 indicates TCI state field refers to single TRP.

In some implementations, each multiple TRP scheme may correspond to a unified TCI states activation/deactivation MAC CE for indicating respective unified TCI state. Preferably, the number of MAC CE may be equal to the number of configured multi-TRP schemes. Preferably, which MAC CE is applied may be based on the received configuration.

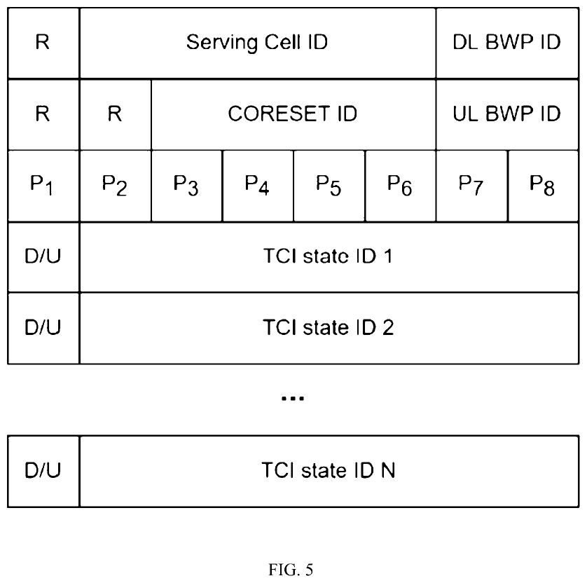

In some implementations, CORESET index may be included in a unified TCI states activation/deactivation MAC CE as illustrated in the FIG. 5. Preferably, the channels/signals that are associated with the corresponding CORESET may apply same unified TCI framework. For example, when a PUCCH with HARQ-ACK codebook scheduled by a PDCCH in a search space associated with CORESET x, the PUCCH may apply same indication as the indication for the PDCCH. Preferably, a CORESET ID with more than one TCI states may correspond to the SFN based multi-TRP scheme.

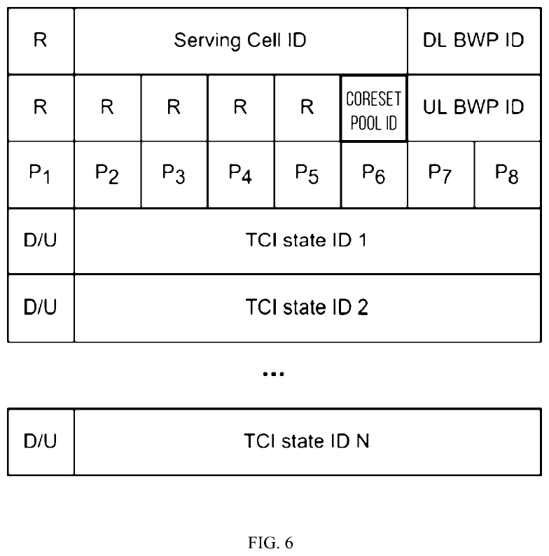

In some implementations, CORESETPoolIndex may be included in a unified TCI states activation/deactivation MAC CE as illustrated in the FIG. 6. Preferably, each CORESETPoolIndex may correspond to the TRP for multi-DCI based multi-TRP scheme.

The following paragraphs provide discussions about configuration for unified TCI states for multi-TRP schemes.

In some implementations, a RRC parameter may be used to configure unified TCI framework for each TRP. Preferably, the RRC parameter may refer to a specific joint state. For example, jointDL, jointUL, jointDLUL may correspond to a unified TCI state indication applies to DL only, UL only, and/or both DL and UL. Preferably, the RRC parameter may indicate a specific TCI state where the TRP applies. Preferably, the UE may receive an RRC message (e.g., RRC Reconfiguration message) including the RRC parameter from the base station, from the TRP of the serving cell, and/or from the TRP associated with a PCI different from the PCI of the serving cell. Upon the reception of the RRC message, the UE may configure itself and/or apply the RRC parameter based on (the information indicated by) the RRC parameter.

In some implementations, a RRC parameter may be used to configure a list to update TCI state for each TRP simultaneously. Preferably, the RRC parameter may correspond to a list including all information related to unified TCI states for multi-TRP. Specifically, each entry in the list may correspond to each TRP. Specifically, each entry in the list may correspond to each multi-TRP scheme.

In some implementations, a RRC configuration may indicate that the unified TCI framework only applies to channels/signals corresponding to same number of TRP. Preferably, the configuration may include same number of configured TCI states for each TRP. Preferably, the configuration containing unified TCI state indication for each channel/signal may refer to same number of TRP indications. Preferably, the RRC configuration may refer to unifedTCIState-Config and include information related to the unified TCI framework for multi-TRP, for example, the number of TRP, TRP indication, multi-TRP scheme, intra-cell indication, and/or inter-cell indication.

In some implementations, a RRC configuration may indicate which channel applies the indicated joint TCI state, and/or the linkage between TCI state of each channel. Preferably, when a specific channel configuration (e.g., PDCCH-Config, PDSCH-Config, PUCCH-Config, and/or PUSCH-Config) includes the unified TCI information, it may imply that the unified TCI state is applied to PDCCH, PDSCH, PUCCH, and/or PUSCH. Preferably, the configuration may include a parameter to indicate the association between channels/signals and TCI state. Preferably, the configuration may include a parameter to indicate the association between different channels, for example, a linkage between a PDCCH to a PDSCH may share the same TCI state for PDCCH and PDSCH, and thus only one of PDCCH TCI states and PDSCH TCI states needs to be activated.

In some implementations, a UE does not expect to receive a RRC configuration that indicates a unified TCI state and a multi-TRP scheme indication at the same time. Preferably, the UE does not expect to receive a configuration that indicates SFN based multi-TRP scheme and the unified TCI framework at the same time.

In some implementations, a RRC parameter configured by the base station may be used to indicate whether a TCI field included in a DCI may indicate two TCI codepoint indexes or not. It is noted that each TCI codepoint index may be associated with different TRPs. Preferably, a RRC parameter configured by the base station may explicitly inform the UE whether a TCI field included in a DCI contains two TCI codepoint indexes or not. For example, if a RRC parameter is set to enable applying unified TCI framework for multi-TRP based operation, the UE may know that the TCI field included in the scheduling DCI may contain two TCI codepoint indices. And each TCI codepoint index is associated with different TRP. Preferably, a RRC parameter may implicitly inform the UE whether a TCI field included in a DCI contains two TCI codepoint indices or not. For example, if there is a RRC parameter indicates the UE to perform multi-TRP based or SFN based operation, the UE may know that the TCI field included in the scheduling DCI may contain two TCI codepoint indices. And each TCI codepoint index is associated with different TRP.

In some implementations, a RRC parameter configured by the base station may be used to indicate whether a DCI includes two TCI fields or not. It is noted that each TCI field may be associated with different TRPs. Preferably, a RRC parameter may explicitly inform the UE whether a DCI includes two TCI fields or not. For example, if a RRC parameter is set to enable containing two TCI fields in one DCI, the UE may know that the DCI may include two TCI fields. It is noted that the TCI field may indicate which TCI state is applied to the UE Preferably, a RRC parameter may implicitly the UE inform the UE whether a DCI includes two TCI fields or not. For example, if there is a RRC parameter indicates the UE to perform multi-TRP based or SFN based operation, the UE may know that the DCI may include two TCI fields. Specifically, each TCI field is associated with different TRPs.

In some implementations, one RRC parameter configured by the base station may be used to indicate to the UE whether to apply unified TCI framework for data transmission/reception. And another RRC parameter configured by the base station may be used to indicate to the UE whether to perform multi-TRP/SFN based operation (e.g., multi-TRP based PDSCH reception, multi-TRP based PUSCH transmission or SFN base PDCCH/PDSCH reception). Preferably, if RRC parameters indicate to the UE to apply unified TCI framework for data transmission/reception and to perform multi-TRP/SFN based operation, the scheduling PDCCH may include two TCI fields. Preferably, if RRC parameters indicate to the UE to apply unified TCI framework for data transmission/reception and to perform multi-TRP/SFN based operation, the TCI field included in scheduling PDCCH may contain two TCI codepoint indices.

The following paragraphs provide discussions about DCI for indicating unified TCI states for multi-TRP schemes.

In some implementations, the UE may receive the DCI from the base station, from the TRP of the serving cell, and/or from the TRP associated with a PCI different from the PCI of the serving cell. Upon the reception of the DCI, the UE may configure itself and/or apply the DCI based on (the information indicated by) the DCI.

In some implementations, more than one TCI codepoints may be included in the DCI. Preferably, a first codepoint may refer to a first TRP and a second codepoint may refer to a second TRP. Preferably, a first codepoint may be used to indicate DL/joint TCI states and a second codepoint may be used to indicate UL TCI states. Preferably, a first codepoint may be used to indicate DL/UL states pair and a second codepoint may be used to indicate joint TCI states. Preferably, each codepoint may correspond to a specific DCI field and a specific RRC parameter. Preferably, a first codepoint may refer to a separate TCI states for a set of configured TRPs.

In one aspect, the codepoint may be used to further activate TCI states for separate TCI state and/or joint TCI state. Preferably, if the RRC configuration configures more than one TCI states for separate TCI state and/or joint TCI state, the codepoint may be used to indicate the activated TCI state for each TRP. Preferably, if the MAC CE indicates more than one TCI states for separate TCI state and/or joint TCI state, the codepoint may be used to indicate the activated TCI state for each TRP. Preferably, single codepoint may indicate one of entries of configured TCI state lists for each TRP.

In one aspect, a field in the DCI scheduling a transmission/reception may be used to indicate different multiple TRP scheme. Preferably, the transmission/reception associated with the DCI may follow the indication in the DCI. Preferably, the transmission/reception associated with the DCI may apply same TCI state indicated by the DCI.

In one aspect, a linked TCI state for different channels from different TRPs may be indicated by DCI. Preferably, a 1-bit field may be used to activate/deactivate the linkage. Preferably, the linked TCI state may indicate the linkage between DL TCI state for TRP#1 and DL TCI state for TRP#2. Preferably, the linked TCI state may indicate the linkage between UL TCI state for TRP#1 and UL TCI state for TRP#2. Preferably, the linked TCI state may indicate the linkage between DL TCI state for TRP#1 and UL TCI state for TRP#2.

In one aspect, when a CORESET is configured with more than one TCI states, the joint TCI state may base on one of the configured TCI states. Preferably, the joint TCI state may refer to a first activated TCI state. Preferably, the joint TCI state may refer to a second activated TCI state. In one aspect, when a UE receives more than one DCI from different CORESETs, the indicated joint TCI state may base on the respective TCI state of each CORESET. Preferably, the received DCI may refer to different CORESETPoolIndex. Preferably, the number of indicated joint TCI states may be the same as the number of received DCI.

In one aspect, more than one TCI fields may be included in the DCI. Preferably, a first TCI field may be associated with a first TRP and a second TCI field may be associated with a second TRP. Preferably, a first TCI field may correspond to a first DCI field, and a second TCI field may correspond to a second DCI field. Preferably, a first TCI field may be associated with a first TCI codepoint, and a second TCI field may be associated with a second codepoint to indicate which TCI state(s) corresponding to the first codepoint is applied to the UE. Preferably, a first TCI field may indicate a first TCI state to the UE for transmitting/receiving signal(s) to/from a first TRP and a second TCI field may indicate a second TCI state to the UE for transmitting/receiving signal(s) to/from a second TRP. It's noted that the type of a first TCI state (e.g., DL TCI state, UL TCI state or joint TCI state) may be aligned with the type of a second TCI state (e.g., DL TCI state, UL TCI state or joint TCI state). More specifically, if the type of a first TCI state is joint TCI state, then the type of a second TCI state is also joint TCI state. Preferably, each TCI field may correspond to a specific DCI format and a specific RRC parameter.

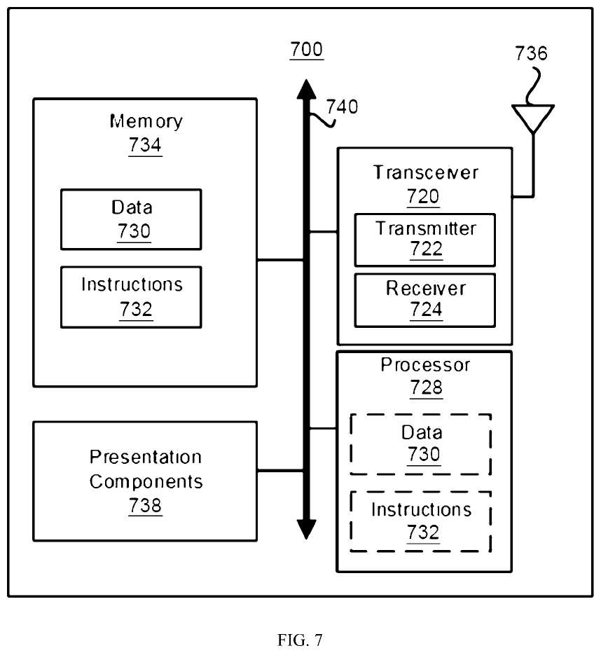

FIG. 7 illustrates a block diagram of a node for wireless communication, in accordance with various aspects of the present application. As shown in FIG. 7, a node 700 may include a transceiver 720, a processor 728, a memory 734, one or more presentation components 738, and at least one antenna 736. The node 700 may also include an RF spectrum band module, a base station communications module, a network communications module, and a system communications management module, Input/Output (I/O) ports, I/O components, and power supply (not explicitly shown in FIG. 7). Each of these components may be in communication with each other, directly or indirectly, over one or more buses 740. In one implementation, the node 700 may be a UE or a base station that performs various functions described herein, for example, with reference to FIGS. 1 through 7-1.

The transceiver 720 having a transmitter 722 (e.g., transmitting/transmission circuitry) and a receiver 724 (e.g., receiving/reception circuitry) may be configured to transmit and/or receive time and/or frequency resource partitioning information. In some implementations, the transceiver 720 may be configured to transmit in different types of subframes and slots including, but not limited to, usable, non-usable and flexibly usable subframes and slot formats. The transceiver 720 may be configured to receive data and control channels.

The node 700 may include a variety of computer-readable media. Computer-readable media can be any available media that can be accessed by the node 700 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 734 may include computer-storage media in the form of volatile and/or non-volatile memory. The memory 734 may be removable, non-removable, or a combination thereof. Exemplary memory includes solid-state memory, hard drives, optical-disc drives, and etc. As illustrated in FIG. 7, The memory 734 may store computer-readable, computer-executable instructions 732 (e.g., software codes) that are configured to, when executed, cause the processor 728 to perform various functions described herein, for example, with reference to FIGS. 1 through 7-1. Alternatively, the instructions 732 may not be directly executable by the processor 728 but be configured to cause the node 700 (e.g., when compiled and executed) to perform various functions described herein.

The processor 728 (e.g., having processing circuitry) may include an intelligent hardware device, e.g., a Central Processing Unit (CPU), a microcontroller, an ASIC, and etc. The processor 728 may include memory. The processor 728 may process the data 730 and the instructions 732 received from the memory 734, and information through the transceiver 720, the base band communications module, and/or the network communications module. The processor 728 may also process information to be sent to the transceiver 720 for transmission through the antenna 736, to the network communications module for transmission to a core network.

One or more presentation components 738 presents data indications to a person or other device. Exemplary presentation components 738 include a display device, speaker, printing component, vibrating component, etc.

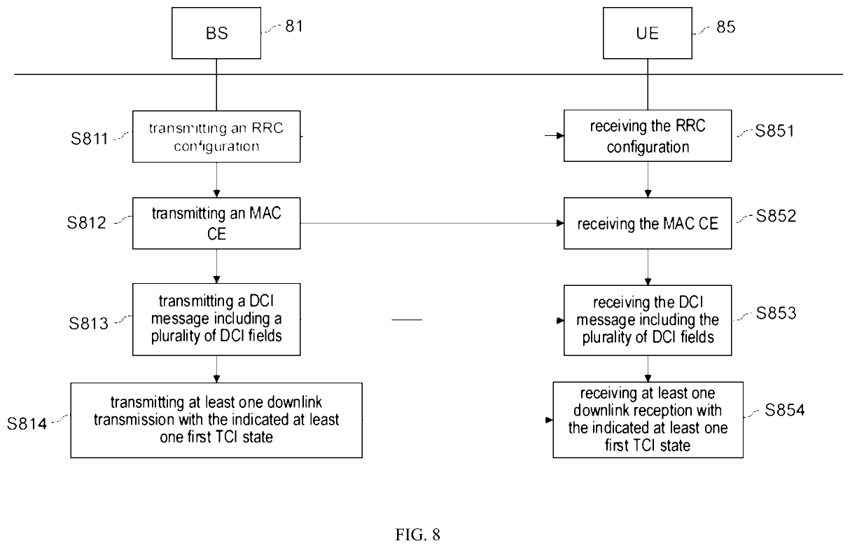

See FIG. 8, which shows a flow chart of the method for communicating based on indicated TCI state according to an embodiment of the disclosure. In the embodiment, the method in FIG. 8 can be carried out by BS 81 and UE 85.

In step S811, the BS 81 transmits an RRC configuration to the UE 85, where the RRC configuration configures multiple TCI fields. Correspondingly, the UE 85 receives the RRC configuration from the BS 81 in step S851.

In one embodiment, each TCI field configured by the RRC configuration may correspond to a specific DCI format and a specific RRC parameter.

In step S812, the BS 81 transmits an MAC CE to the UE 85, where the MAC CE activates at least one TCI state associated with the plurality of TCI fields. Correspondingly, the UE 85 receives the MAC CE from the BS 81 in step S852.

In one embodiment, the MAC CE further includes more than one MAC CE fields activating the at least one TCI state for multiple TRP downlink receptions or multiple TRP uplink transmissions.

In one embodiment, the MAC CE is different from another MAC CE for activating at least one other TCI state for the single TRP operation.

In one embodiment, the MAC CE received by the UE 85 in step S852 may be the unified TCI states activation/deactivation MAC CE transmitted by the BS 81, the TRP associated with the serving cell, and/or the TRP associated with a PCI different from the PCI of the serving cell. Upon the reception of the unified TCI states activation/deactivation MAC CE, the UE 85 may apply (the information indicated in) the unified TCI states activation/deactivation MAC CE, but the disclosure is not limited thereto.

In step S813, the BS 81 transmits a DCI message including multiple DCI fields to the UE 85, where the plurality of DCI fields are associated with the received RRC configuration and indicate at least one first TCI state among the activated at least one TCI state. Correspondingly, the UE 85 receives the DCI message including the plurality of DCI fields from the BS 81 in step S853.

In one embodiment, an RRC parameter configured by the BS 81 in the RRC configuration may be used to indicate whether the DCI message includes two DCI fields or not. In some embodiments, the DCI fields in the DCI message can one-to-one correspond to the TCI fields configured by the RRC configuration, but the disclosure is not limited thereto.

In various embodiments, the at least one first TCI state is a DL TCI state (i.e., a TCI state used for DL scenario), a UL TCI state (i.e., a TCI state used for UL scenario), or a joint TCI state (i.e., a TCI state used for both of the UL and DL scenarios), but the disclosure is not limited thereto.

In one embodiment, when a CORESET is configured with more than one TCI states, the joint TCI state may base on one of the configured TCI states.

In one embodiment, one RRC parameter of the RRC configuration may be used to indicate to the UE 85 whether to apply unified TCI framework for data transmission/reception, and another RRC parameter of the RRC configuration may be used to indicate to the UE 85 whether to perform multi-TRP/SFN based operation (e.g., multi-TRP based PDSCH reception, multi-TRP based PUSCH transmission or SFN based PDCCH/PDSCH reception).

In one embodiment, the at least one indicated first TCI state includes multiple indicated second TCI states, and one of the plurality of DCI fields in the DCI message indicates which of the indicated second TCI states is applied.

In one embodiment, more than one TCI fields may be included in the DCI. Preferably, a first TCI field may indicate a first TCI state to the UE 85 for transmitting/receiving signal(s) to/from a first TRP, and a second TCI field may indicate a second TCI state to the UE for transmitting/receiving signal(s) to/from a second TRP, but the disclosure is not limited thereto.

In one embodiment, each of the plurality of DCI fields in the DCI message corresponds to a TCI codepoint.

In step S814, the BS 81 transmits at least one downlink transmission with the indicated at least one first TCI state. Correspondingly, the UE 85 receives at least one downlink reception with the indicated at least one first TCI state in step S854.

In some embodiments, the DCI message corresponds to a DCI format scheduling the at least one downlink reception of the UE 85 (i.e., the at least one downlink transmission from the BS 81).

In one embodiment, the at least one downlink reception is configured with one or more repeated transceiving operation in a time domain or in a frequency domain. For example, the same downlink reception in the time domain or the frequency domain can be repeatedly performed by the UE 85 for four times or eight times, but the disclosure is not limited thereto.

In different embodiments, the downlink reception of the UE 85 includes PDSCH, PDCCH, CORESET, or DL reference signal reception, but the disclosure is not limited thereto. For example, the UE 85 may receive signals, from the BS 81, transmitted on PDSCH, PDCCH, or the like based on the indicated at least one first TCI state. Additionally or alternatively, the UE 85 may receive signals, from the BS 81, on CORESET based on the indicated at least one first TCI state. Additionally or alternatively, the UE 85 may receive DL reference signals from the BS 81 the indicated at least one first TCI state, but the disclosure is not limited thereto.

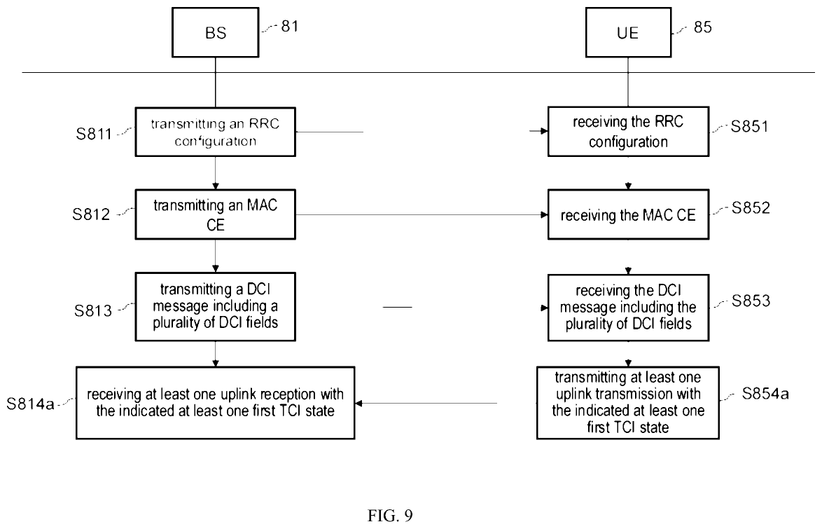

See FIG. 9, which shows another flow chart of the method for communicating based on indicated TCI state according to an embodiment of the disclosure. In the embodiment, the method in FIG. 9 can be carried out by BS 81 and UE 85.

In FIG. 9, descriptions of steps S811 to S813 and steps S851 to S853 can be referred to the descriptions associated with FIG. 8, which would not be repeated herein.

The difference between FIG. 9 and FIG. 8 is that after step S853, the UE 85 performs step S854a to transmit at least one uplink transmission with the indicated at least one first TCI state. Correspondingly, the BS 81 receives at least one uplink reception with the indicated at least one first TCI state in step S814a.

In some embodiments, the DCI message corresponds to a DCI format scheduling the at least one uplink reception of the BS 81 (i.e., the at least one uplink transmission from the UE 85).

In one embodiment, the at least one uplink transmission is configured with one or more repeated transceiving operation in a time domain or in a frequency domain. For example, the same uplink transmission in the time domain or the frequency domain can be repeatedly performed by the UE 85 for four times or eight times, but the disclosure is not limited thereto.

In different embodiments, the uplink transmission includes PUSCH, PUCCH, or UL reference signal transmission, but the disclosure is not limited thereto. For example, the UE 85 may transmit signals, to the BS 81, on PUSCH, PUCCH, or the like based on the indicated at least one first TCI state. Additionally or alternatively, the UE 85 may transmit UL reference signals to the BS 81 based on the indicated at least one first TCI state, but the disclosure is not limited thereto.

Based on the above, embodiments of the disclosure provide solutions for the communication system in the case where the unified TCI state is used with multi-TRP.

From the above description, it is manifested that various techniques may be used for implementing the concepts described in the present application without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A user equipment (UE), comprising:
at least one non-transitory computer-readable medium storing one or more computer-executable instructions; and
at least one processor coupled to the at least one non-transitory computer-readable medium and configured to execute the one or more computer-executable instructions to cause the UE to:
receive, from a base station (BS), a Radio Resource Control (RRC) configuration that configures, to the UE, a plurality of Transmission Configuration Indicator (TCI) fields;
receive, from the BS, a Medium Access Control (MAC) Control Element (CE) that activates at least one TCI state associated with the plurality of TCI fields;
receive, from the BS, a downlink control information (DCI) message including a plurality of DCI fields that is associated with the received RRC configuration and that indicates at least one first TCI state among the activated at least one TCI state; and
perform, based on the indicated at least one first TCI state, at least one downlink reception or at least one uplink transmission.

2. The UE of claim 1, wherein the DCI message corresponds to a DCI format scheduling the at least one downlink reception or the at least one uplink transmission.

3. The UE of claim 1, wherein the MAC CE comprises more than one MAC CE field for activating the at least one TCI state for a plurality of Transmission and Reception Point (TRP) downlink receptions or a plurality of TRP uplink transmissions.

4. The UE of claim 1, wherein the indicated at least one first TCI state comprises a Downlink (DL) TCI state, an Uplink (UL) TCI state, or a joint TCI state.

5. The UE of claim 1, wherein the at least one downlink reception or the at least one uplink transmission is configured with one or more repeated transceiving operations in time domain or in frequency domain.

6. The UE of claim 1, wherein the MAC CE is different from another MAC CE that is for activating at least one second TCI state for a single TRP operation.

7. The UE of claim 1, wherein;
the indicated at least one first TCI state comprises a plurality of indicated second TCI states, and
one of the plurality of DCI fields in the DCI message indicates which of the indicated second TCI states is applied.

8. The UE of claim 1, wherein each of the plurality of DCI fields in the DCI message corresponds to a TCI codepoint.

9. The UE of claim 1, wherein;
the at least one uplink transmission comprises a physical uplink shared channel (PUSCH), a physical uplink control channel (PUCCH), or an uplink (UL) reference signal transmission, and the at least one downlink reception comprises a physical downlink shared channel (PDSCH), a physical downlink control channel (PDCCH), a control resource set (CORESET), or a downlink (DL) reference signal reception.

10. A method performed by a user equipment (UE) for communicating based on an indicated Transmission Configuration Indicator (TCI) state, the method comprising:
receiving, from a base station (BS), a Radio Resource Control (RRC) configuration that configures, to the UE, a plurality of Transmission Configuration Indicator (TCI) fields;
receiving, from the BS, a Medium Access Control (MAC) Control Element (CE) that activates at least one TCI state associated with the plurality of TCI fields;
receiving, from the BS, a downlink control information (DCI) message including a plurality of DCI fields that is associated with the received RRC configuration and that indicates at least one first TCI state among the activated at least one TCI state; and
performing, based on the indicated at least one first TCI state, at least one downlink reception or at least one uplink transmission.

11-18. (canceled)

19. A base station (BS), comprising:
at least one non-transitory computer-readable medium storing one or more computer-executable instructions; and
at least one processor coupled to the at least one non-transitory computer-readable medium and configured to execute the computer-executable instructions to cause the BS to:
transmit, to a user equipment (UE), a Radio Resource Control (RRC) configuration that configures, to the UE, a plurality of Transmission Configuration Indicator (TCI) fields;
transmit, to the UE, a Medium Access Control (MAC) Control Element (CE) that activates at least one TCI state associated with the plurality of TCI fields;
transmit, to the UE, a downlink control information (DCI) message including a plurality of DCI fields that is associated with the received RRC configuration and that indicates at least one first TCI state among the activated at least one TCI state; and
perform, based on the indicated at least one first TCI state, at least one downlink transmission or at least one uplink reception.

20. (canceled)
